(19) United States
(12) Patent Application Publication
(10) Pub. No.: US 2022/0113863 A1
(43) Pub. Date: Apr. 14, 2022

(54) DISPLAYING INFORMATION RELATED TO THE ITEM/S

(71) Applicant: Carrier Corporation, Palm Beach Gardens, FL (US)

(72) Inventor: Ramakrishna Gattu, Hyderabad, Telangana (IN)

(21) Appl. No.: 17/251,416

(22) PCT Filed: Jun. 30, 2020
(86) PCT No.: PCT/IB2020/056163

§ 371 Date: Dec. 11, 2020

(30) Foreign Application Priority Data
Jul. 2, 2019 (IN) 201911026531

(51) Int. Cl. G06F 3/04883; G06K 19/07; B65D 79/02; G06F 3/04886

(52) U.S. Cl. CPC G06F 3/04883; G06F 3/04886; B65D 79/02; G06K 19/0717

(57) ABSTRACT

Aspects of the invention are directed towards sensing environmental parameters associated with an item and displaying information related to the item. One or more embodiments of the invention describe sensing, by one or more sensors, at least one environmental parameter associated with an item and validating, by a processor, the sensed environmental parameter with a pre-configured data stored in a memory. One or more embodiments of the invention further describe displaying information related to the item based on said validation, the information displayed on an electronic display coupled to the item.

### TECHNICAL FIELD OF INVENTION

The present invention relates generally to monitoring of items. More particularly, the invention relates to sensing of environmental parameters associated with an item and displaying information related thereto.

### BACKGROUND OF THE INVENTION

Today, transportation of one or more items having content from one place to another place is a common practice. The items can be transported from the manufacturer's place to a retail store or from one manufacturer's place to another. Further, some manufacturers of items may define a specific threshold or limit for maintaining environmental parameters (like temperature, humidity or air pressure) in order to keep the contents of the items fresh or prevent the items from becoming stale/unusable. Furthermore, the environmental parameters may vary which may cause an adverse effect on the contents of the items. Due to the change in the environmental parameters, the chemical composition of the item's content can get modified affecting the health of the item's content or at times, making the contents of the items non-consumable/unusable for end consumers. However, when the item reaches the end consumers, the consumers will never know that the content of the item has become stale or non-consumable/unusable because of the changes in the composition of the contents present in the items due to changes in the environmental parameters during the transit of the item.

Currently, the manufacturer of items provides paper labels on these items specifying the threshold/limit for maintaining environmental parameters for the items. But, these labels get damaged or removed from the items if some water or any like material spills over such labels. Also, the existing solutions for informing the end consumers regarding the changes in the composition of the content of the items require connectivity with a network or a cloud, which connects with the end consumers through an application. However, in absence of such connectivity with the network or the cloud, the consumers do not get this information in a timely manner or get such information after consuming/using the content of the items. The consumption/usage of such items by the end consumers can drastically affect the health of the end consumers.

In view of afore-mentioned problems in the existing solutions, there is a need of effective system and method for informing the consumers regarding an indication of the changes in the composition of the content of the items in a timely manner and providing an alert thereof. There is also a need to check whether a given environment is suitable for storage of the item. There is also a need for informing the consumers regarding the changes in the composition of the content of the items without requiring any connectivity with a network or a cloud. In order to solve the problems in the existing solutions, systems and methods are disclosed for sensing and displaying environmental parameters associated with content of an item.

### SUMMARY OF THE INVENTION

Various embodiments of the invention describe a method and an item for sensing environmental parameters associated with the item and displaying information related to the item. The invention discloses an item including an electronic device coupled to the item and displaying information related to the item. The electronic device comprises one or more sensors configured to sense at least one environmental parameter associated with the item and a processor to validate the sensed environmental parameter with a pre-configured data. The electronic device also comprises a memory coupled to the processor configured to store the pre-configured data. An electronic display is coupled to the electronic device and configured to display information related to the item based on said validation.

In an embodiment of the invention, the electronic display is an electronic paper display which is configured to display alert based on the validation, wherein the alert is displayed if there is a change in a value of the pre-configured data of the sensed environmental parameter.

In an alternative embodiment of the invention, the item is coupled to a temperature sensor or a humidity sensor to sense temperature or a humidity, respectively.

In a further embodiment of the invention, the information related to the item is updated on the electronic display upon a detection of a gesture on the item. The gesture comprises opening of a cap of the item, pressing the item, tapping on the item, shaking the item, or holding the item.

In yet another embodiment of the invention, the item is further coupled with an accelerometer or a gyrometer for detecting gesture on the item.

In another embodiment of the invention, the information displayed on the electronic display is updated periodicallyand the information includes usability of the item.

In an embodiment of the invention, the electronic display is an electronic paper display.

In yet another embodiment of the invention, a method is disclosed for sensing environmental parameters associated with an item and displaying information related to the item. The method comprises the steps of sensing at least one environmental parameter associated with an item, the item coupled with one or more sensors to sense the at least one environmental parameter. The method further comprises the steps of validating, by a processor, the sensed environmental parameter with a pre-configured data stored in a memory. Based on said validation, information related to the item is displayed on an electronic display the electronic display is coupled to the item.

In an embodiment of the invention, the processor, the memory, the one or more sensors, and the electronic display comprise an electronic device.

In another embodiment of the invention, the electronic display is configured to display alert based on the validation, wherein the alert is displayed if there is a change in a value of the pre-configured data of the sensed environmental parameter.

In another embodiment of the invention, the item is coupled to a temperature sensor or humidity sensor to sense temperature or a humidity, respectively.

In a further embodiment of the invention, the information comprises includes a message, an alert, an image, an expiry date of the item, a time stamp of last updated information, an information regarding tampering of the item, or a data corresponding to the sensed environmental parameter. Further, the information is updated on the electronic display upon a detection of a gesture on the item. The gesture comprises opening of a cap of the item, pressing the item, tapping on the item, shaking the item, or holding the item.

In another embodiment of the invention, the information displayed on the electronic display is updated periodicallyand the information includes usability of the item.

In yet another embodiment of the invention, the item is further coupled with an accelerometer or a gyrometer for detecting gesture on the item.

In an embodiment of the invention, the electronic display is an electronic paper display.

In various other embodiments of the invention, a computer readable medium is disclosed comprising one or more processors and a memory coupled to the one or more processors. The memory stores instructions which are executed by the one or more processors to sense at least one environmental parameter associated with an item, the item coupled with one or more sensors to sense the at least one environmental parameter. Further, the sensed environmental parameter are validated, by a processor, with a pre-configured data stored in a memory. And, based on said validation, information related to the item is displayed on an electronic display the electronic display is coupled to the item.

In an embodiment of the invention, the processor, the memory, the one or more sensors, and the electronic display comprise an electronic device.

This summary is provided to introduce a selection of concepts in a simplified form from that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 depicts an exemplary item according to an exemplary an embodiment of the invention.

FIG. 2 depicts an exemplary block diagram of different components in an electronic device coupled to an item according to an exemplary embodiment of the invention.

FIG. 3 depicts an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology for sensing environmental parameters associated with an item and displaying information related to the item.

As used herein, the item includes content for consumption or usage by an end customer. Such item may be a bottle or a box having liquid content, solid content or semi solid content or any such item known in the art. The content in the item may be for any kind of consumption/usage and may be a pharmaceutical content, a liquid content, an eatable content, a lotion, a cream, tablets or any such content known in the art.

As used herein, the environmental parameters that are to be sensed by one or more sensors may include, but not limited to, temperature, humidity, air pressure or any such external environment parameter that is known in the art.

As used herein, the one or more sensors may possess capability of sensing/monitoring the one or more environmental parameters associated with the item. The one or more sensors can sense the temperature, humidity, or air pressure of the external environment where the item is placed or present. The one or more sensors may include, but not limited to, a temperature sensor, a humidity sensor, an air pressure sensors or any such sensor that is obvious to a person skilled in the art.

As used herein, the information relating to the item comprises a message, an alert, an image, an expiry date of the item, a time stamp of last updated information, graphical representation of sensed environmental parameters, an information regarding tampering of the item or any such data corresponding to the sensed environmental parameters.

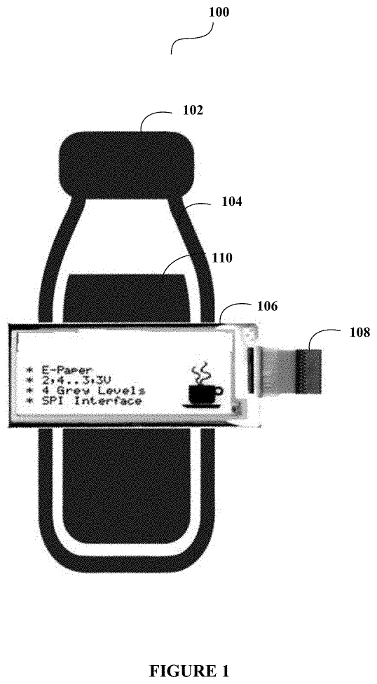

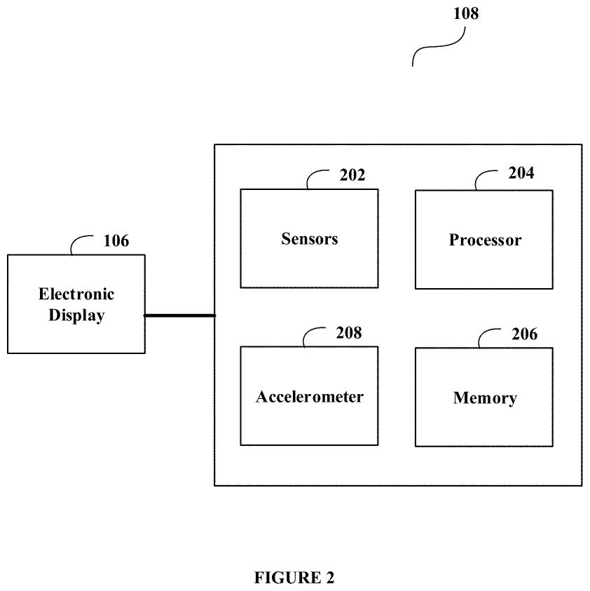

FIG. 1 depicts an exemplary item 100 for sensing environmental parameters associated with an item and displaying information related to the item, according to an exemplary embodiment of the invention. As depicted in FIG. 1, the item 100 includes a cap 102 to be fitted on a body 104, and an electronic device 108 coupled with the item 100. Also, the item 100 includes content 110 in the body 104 of the item 100. Further, the electronic device 108 includes an electronic display 106, one or more sensors 202, a processor 204, and a memory 206 as depicted in the FIG. 2. In an embodiment of the invention, the electronic display is an electronic paper display. The one or more sensors 202 is configured to sense at least one environmental parameters associated with the item 100. For example, the one or more sensors 202 in the electronic device 108 senses the air temperature and humidity at a place where the item 100 is situated. The processor 204 in the electronic device 108 receives the sensed environmental parameter from the one or more sensors 202 and validates the sensed environmental parameter with a pre-configured data. The pre-configured data is stored in the memory 206 and is configured by a manufacturer of the item 100 at the time of manufacturing or packaging of the item 100. The pre-configured data includes one or more values which may be a specific threshold or limit for environmental parameters within which the item 100 needs to be maintained or placed.

The processor 204 in the electronic device 108 is configured to validate the sensed environmental parameter by comparing values of sensed environmental parameter with the threshold values of the pre-configured data of the item 100. Further, based on the validation, the processor 204 provides information to the electronic display 106. In one embodiment, the processor 204 generates an alert if the sensed environmental parameter reaches above the threshold value of the pre-configured data. In an alternative embodiment, the processor 204 generates an alert if the sensed environmental parameter reaches below the threshold value of the pre-configured data. Based on the validation, the processor 204 provides information to the electronic display 106. Such information comprises a message, alert, an image, an expiry date of the item 100, a time stamp of last updated information, an information regarding tampering of the item or a data corresponding to the sensed environmental parameters, graphical representation of sensed environmental parameters, an information regarding tampering of the item or any such information well-known in the art. The memory 206 is also configured to store the information related to the item 100 upon the validation of the sensed environmental parameters.

The electronic display 106 receives the information from the processor 204 based on the validation performed by the processor 204 and accordingly, the electronic display 106 displays such information related to the item 100. Considering an example where the manufacturer of the item 100 defines a threshold of 22 degrees celsius temperature for keeping the item 100 and above such threshold, the content 110 in the item may get stale or becomes inappropriate for consumption/usage. Assuming the temperature in the air is 35 degree celsius and when the one or more sensors 202 of the item 100 provides the sensed temperature value to the processor 204, the processor 204 in the electronic device 108 compares 35 degree celsius with 22 degrees celsius (i.e. preconfigured data). In such case, the processor 204 generates an alert and provides an appropriate message to the electronic display 106. In a different situation, where the manufacturer of the item 100 defines a threshold of 5 degrees celsius temperature for keeping the item 100 and below such cold storage threshold, the content in the item may get stale or becomes inappropriate for consumption/usage. Assuming the temperature in the air is 3 degree celsius and the processor 204 in the electronic device 108 compares 3 degree celsius with 5 degrees celsius (i.e. preconfigured data). In such a case, the processor 204 generates an alert and provides the message to the electronic display 106 as the content 110 in the item 100 gets stale below such temperature.

Accordingly, the alert on the electronic display 106 informs a consumer/user of the item.

Furthermore, the electronic device 108 includes an accelerometer/gyrometer 208 as depicted in the FIG. 2. The accelerometer/gyrometer 208 is configured to detect gesture/s on the item 100. Such gesture is made by the user/consumer on the item 100 and may include opening the cap 102 of the item 100, pressing the cap 102, tapping (single tap or double tap) on the item 100, shaking the item 100, holding the item 100 or any gesture made by the user on the item 100. Based on the detection of the gesture on the item 100 by the accelerometer/gyrometer 208, the information is updated or refreshed on the electronic display 106. Alternatively, the information may be updated on the electronic display periodically, irrespective of any gesture event from the user. Also, the information displayed on the electronic display 106 remains intact even after battery is drained. The information on the electronic display 106 is refreshed when the gesture is detected on the item 100 using the accelerometer/gyrometer 208. It is noted that the parameters are sensed periodically, however the electronic display 106 is refreshed on detecting the gesture to reduce the power consumption by the electronic display. Although, the present invention entails the electronic device 108 which includes the electronic display 106; however, it is well understood by a person skilled in the art that the electronic display 106 may be coupled with the electronic device 108. Further, the present invention depicts and illustrates the electronic device 108 coupled with the item 100, however, it is well understood by a person skilled in the art that the electronic display 106, the one or more sensors 202, the processor 204, and the memory 206 of the electronic device 108 are also coupled with the item 100.

The present invention also encompasses a situation where the time parameter related with the item 100 is taken into consideration for determining if the content 110 in the item 100 has become stale. For instance, if the content 110 in the item 100 is kept at a temperature below/above the pre-configured data for a 1-2 minutes, then in such a scenario, the content 110 in the item 100 may not become stale. However, if the content 110 in the item 100 is kept at a temperature below/above the pre-configured data for more than 30 minutes (or for some pre-configured time by the manufacturer), then in such a scenario, the content 110 in the item 100 may become stale.

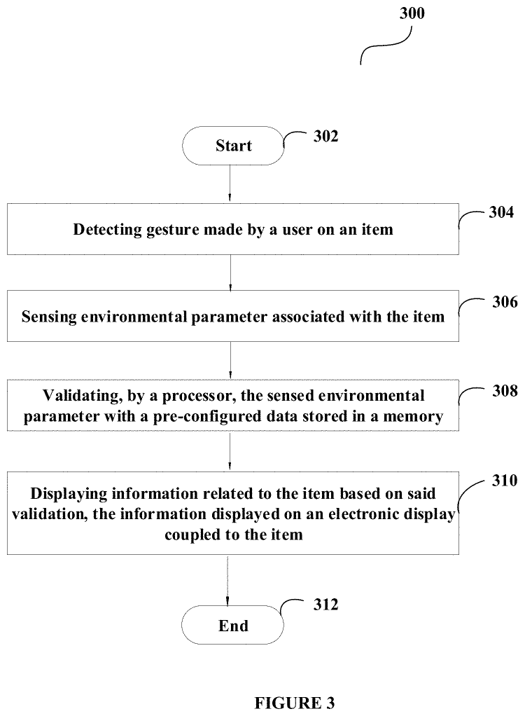

FIG. 3 depicts a flowchart outlining the features of the invention in an exemplary embodiment of the invention. The method flowchart 300 describes a method being performed for enabling the invention. The method flowchart 300 starts at step 302.

At step 304, the accelerometer/gyrometer 208 detects the gesture/s on the item 100. Such a gesture is made by the user/consumer on the item 100 and may include opening the cap 102 of the item 100, pressing the cap 102, tapping (single tap or double tap) on the item 100, shaking the item 100, holding the item 100 or any gesture made by the user on the item 100.

At step 306, the one or more sensors 202 sense the at least one environmental parameter associated with the item 100. For example, the one or more sensors 202 in the electronic device 108 are coupled with the item 100 and senses the air temperature or humidity or both where the item 100 is placed or situated. It is understood that any other parameters related to environment and surroundings which can be sensed by the sensors are within the scope of the invention.

At step 308, the processor 204 is configured to validate the sensed environmental parameter by comparing values of sensed environmental parameter with the pre-configured data stored in the memory 206. Further, based on the validation, the processor 204 provides information to the electronic display 106. In one embodiment, the processor 204 generates an alert if the sensed environmental parameter reaches above a threshold value of the pre-configured data. In an alternative embodiment, the processor 204 generates an alert if the sensed environmental parameter reaches below a threshold value of the pre-configured data. Based on the validation, the processor 204 provides information to the electronic display 106. Such information includes a message, alert, an image, an expiry date of the item 100, a time stamp of last updated information, or data corresponding to the sensed environmental parameters, graphical representation of sensed environmental parameters, tampering of the item or any such information well-known in the art.

At step 310, the electronic display 106 is coupled with the item 100 and receives the information from the processor 204 based on the validation performed by the processor 204. Accordingly, the electronic display 106 displays such information related to the item 100. The method flowchart ends at 312.

The present invention is applicable in various fields such as, but not limited to, pharmaceutical industry, cosmetics industry, food industry and any such industry producing environmentally sensitive content and is well known in the art.

The present invention provides the following technical advantages over the existing methods and systems: a) continuous display of the information on the electronic display without draining the battery, b) updating information on the electronic display upon detection of a gesture, c) informing consumer/user in a timely manner about the health of the item, d) restricting the consumer/user for consuming/using the stale products, e) checking integrity of the item, f) informing consumer/user about the item without requiring any network or interne, and g) monitoring of the items during transit.

The embodiments of the invention discussed herein are exemplary and various modification and alterations to a known person skilled in the art are within the scope of the invention.

In one embodiment of the invention, the invention can be operated using the one or more computer readable devices comprising a computer readable medium. The one or more computer readable devices can be associated with the item 100. The computer readable medium of the computer readable devices is configured to sense at least one environmental parameter associated with an item 100, the item 100 coupled with one or more sensors 202 to sense the at least one environmental parameter. The sensed environmental parameter is validated by a processor 204 with a pre-configured data stored in the memory 206. After validation, information related to the item is displayed on the electronic display 106 which is coupled to the item 100 and may look similar to a paper label. Further, the processor 204, the memory 206, the one or more sensors 202, and the electronic display 106 comprises the electronic device 108.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method comprising:
sensing at least one environmental parameter associated with an item, the item coupled with one or more sensors to sense the at least one environmental parameter;
validating, by a processor, the sensed environmental parameter with a pre-configured data stored in a memory; and
displaying information related to the item based on said validation, the information displayed on an electronic display coupled to the item.

2. The method of claim 1, wherein the processor, the memory, the one or more sensors, and the electronic display comprise an electronic device.

3. The method of claim 1, further comprising, displaying an alert on the electronic display based on the validation, wherein the alert is displayed if there is a change in a value of the pre-configured data of the sensed environmental parameter.

4. The method of claim 1, wherein the item is coupled to a temperature sensor or a humidity sensor to sense temperature or humidity, respectively.

5. The method of claim 1, wherein the information related to the item is updated on the electronic display upon detection of a gesture on the item.

6. The method of claim 5, wherein the item is further coupled with an accelerometer or a gyrometer for detecting the gesture on the item.

7. The method of claim 5, wherein the gesture comprises opening of a cap of the item, pressing the item, tapping on the item, shaking the item, or holding the item.

8. The method of claim 1, wherein the information comprises a message, an alert, an image, an expiry date of the item, a time stamp of last updated information, an information regarding tampering of the item, or a data corresponding to the sensed environmental parameter.

9. The method of claim 1, wherein the information displayed on the electronic display is updated periodically and the information indicates usability of the item.

10. The method of claim 1, wherein the electronic display is an electronic paper display.

11. An item comprising:
an electronic device coupled to the item for displaying information related to the item, the electronic device comprising:
one or more sensors configured to sense at least one environmental parameter associated with the item;
a processor configured to validate the sensed environmental parameter with a pre-configured data; and
a memory coupled to the processor configured to store the pre-configured data; and
an electronic display coupled to the electronic device and configured to display information related to the item based on said validation.

12. The item of claim 11, wherein, the electronic display is configured to display an alert based on the validation, wherein the alert is displayed if there is a change in a value of the pre-configured data of the sensed environmental parameter.

13. The item of claim 11, wherein the item is coupled to a temperature sensor or a humidity sensor to sense temperature or a humidity, respectively.

14. The item of claim 11, wherein the information is updated on the electronic display upon a detection of a gesture on the item.

15. The item of claim 14, wherein the item is further coupled with an accelerometer or a gyrometer for detecting the gesture on the item.

16. The item of claim 14, wherein the gesture comprises opening of a cap of the item, pressing the item, tapping on the item, shaking the item, or holding the item.

17. The item of claim 11, wherein the information displayed on the electronic display is updated periodically and the information includes usability of the item.

18. The item of claim 11, wherein the electronic display is an electronic paper display.

19. A computer readable medium comprising one or more processors and a memory coupled to the one or more processors, the memory storing instructions which are executed by the one or more processors, the one or more processors configured to:
sense at least one environmental parameter associated with an item, the item coupled with one or more sensors to sense the at least one environmental parameter;
validate, by a processor, the sensed environmental parameter with a pre-configured data stored in a memory; and
display information related to the item based on said validation, the information displayed on an electronic display coupled to the item.

20. The computer readable medium of claim 19, wherein the processor, the memory, the one or more sensors, and the electronic display comprise an electronic device.
